(19) United States
(12) Patent Application Publication
(10) Pub. No.: US 2019/0296288 A1
(43) Pub. Date: Sep. 26, 2019

(54) BATTERY MODULE AND MANUFACTURING METHOD OF BATTERY MODULE

(71) Applicant: Honda Motor Co.,Ltd., Tokyo (JP)

(72) Inventor: Atsushi SAKURAI, Saitama (JP)

(73) Assignee: Honda Motor Co.,Ltd., Tokyo (JP)

(21) Appl. No.: 16/360,024

(22) Filed: Mar. 21, 2019

(30) Foreign Application Priority Data
Mar. 22, 2018 (JP) 2018-054689

(51) Int. Cl. H01M 2/10; H01M 10/0587; H01M 2/02; H01M 2/08; H01M 2/20

(52) U.S. Cl. CPC H01M 2/1077; H01M 10/0587; H01M 2/206; H01M 2/08; H01M 2/0237

(57) ABSTRACT

The battery module includes a plurality of battery cells arranged therein. The battery cells are housed in an enclosing member, which is open on upper and lower sides, to be surrounded by the enclosing member. The battery cell stores an electrode body formed by winding a collector foil inside a cell case, which has long side walls and short side walls. The battery cell has a space between a corner where the long side wall and the short side wall intersect each other and the electrode body. The cell case has a recess partially depressed toward the space at the corner. A resin molded part molded of a resin is provided between the battery cells and the enclosing member and between the adjacent battery cells. The resin of the resin molded part enters the recess.

### CROSS-REFERENCE TO RELATED APPLICATION

This application claims the priority of Japan patent application serial no. 2018-054689, filed on Mar. 22, 2018. The entirety of the above-mentioned patent application is hereby incorporated by reference herein and made a part of this specification.

### BACKGROUND

### Technical Field

The disclosure relates to a battery module and a manufacturing method of the battery module.

### Description of Related Art

A hybrid car or electric vehicle is provided with a battery module, in which a plurality of battery cells such as lithium ion secondary batteries are arranged in parallel. In the battery cell, an electrode body composed of a collector foil is stored in a cell case that is made of a metal material such as aluminum. The adjacent battery cells are not in direct contact with each other to achieve insulation between the battery cells.

For example, Patent Document 1 discloses that an insulation layer composed of a resin material is disposed on a side surface of a container body that constitutes the battery cell. In addition, Patent Document 2 discloses that the adjacent battery cells are connected to each other at fixed intervals by a fixing member.

### RELATED ART

### Patent Document

[Patent Document 1] Japanese Laid-open No. 2015-144068
[Patent Document 2] Japanese Laid-open No. 2014-192052

### Problems to be Solved

Generally, battery cells expand due to charging and discharging. In addition, there is a concern that vibration of the vehicle may cause displacement of the battery cells. For these reasons, in the conventional battery module, all the battery cells are fastened with a metal band or the like to be firmly integrated. However, since it is necessary to separately prepare and assemble parts such as the metal band, the structure of the battery module is complicated and the cost is high.

### SUMMARY

A battery module (for example, the battery module 1 described later) according to the disclosure includes a plurality of battery cells (for example, the battery cells 3 described later) arranged therein. The battery cells are housed in an enclosing member (for example, the enclosing member 2 described later), which is open on upper and lower sides, to be surrounded by the enclosing member. Each of the battery cells stores an electrode body (for example, the electrode body 34 described later), which is formed by winding a collector foil (for example, the collector foil 340 described later), inside a cell case (for example, the cell case 33 described later) including long side walls (for example, the long side walls 331 described later) and short side walls (for example, the short side walls 332 described later), and has a space (for example, the space S described later) between a corner (for example, the corner 33c described later) where the long side wall and the short side wall intersect each other and the electrode body. The cell case has a recess (for example, the recess 37 described later) partially depressed toward the space at the corner. The battery module includes a resin molded part (for example, the resin molded part 4 described later) molded of a resin between the battery cells and the enclosing member and between the adjacent battery cells, and the resin (for example, the resin 41 described later) of the resin molded part enters the recess.

A manufacturing method according to the disclosure is for manufacturing a battery module (for example, the battery module 1 described later), in which a plurality of battery cells (for example, the battery cells 3 described later) are arranged. The manufacturing method includes: a housing process of arranging and housing a plurality of cell cases (for example, the cell cases 33 described later) in an enclosing member (for example, the enclosing member 2 described later), which is open on upper and lower sides, so that the cell cases are surrounded by the enclosing member, wherein each of the cell cases has a recess (for example, the recess 37 described later) partially depressed toward an inner side of the cell case at a corner (for example, the corner 33c described later) where a long side wall (for example, the long side wall 331 described later) and a short side wall (for example, the short side wall 332 described later) of the cell case intersect each other; a resin molding process of forming a resin molded part (for example, the resin molded part 4 described later) by integrally molding a resin between the cell cases housed in the enclosing member and the enclosing member and between the adjacent cell cases, wherein the resin (for example, the resin 41 described later) of the resin molded part enters the recess; an electrode body storing process of storing an electrode body (for example, the electrode body 34 described later), which is formed by winding a collector foil (for example, the collector foil 340 described later), into each of the cell cases after the resin molded part is formed; and a sealing body attaching process of attaching a sealing body (for example, the sealing body 31 described later) to the cell case storing the electrode body.

### BRIEF DESCRIPTION OF THE DRAWINGS

FIG. 1 is a perspective view of the battery module according to an embodiment of the disclosure.

FIG. 2 is a cross-sectional view taken along the line A-A in FIG. 1.

FIG. 3 is a front view of the battery cell.

FIG. 4 is a front view showing the battery cell shown in FIG. 3 in an exploded manner.

FIG. 5 is a cross-sectional view taken along the line B-B in FIG. 3.

FIG. 6 is a perspective view showing the electrode body according to another embodiment, which is wound in the longitudinal direction.

FIG. 7 is a cross-sectional view of the battery cell, in which the electrode body shown in FIG. 15 is stored, taken by cutting along the same portion as the line B-B in FIG. 3.

FIG. 8 is a perspective view of the lower mold used for manufacturing the battery module according to an embodiment of the disclosure.

FIG. 9 is a perspective view showing a state where the cell cases are mounted on the lower mold shown in FIG. 6.

FIG. 10 is a perspective view showing a state where the enclosing member is mounted on the lower mold, on which the cell cases are mounted.

FIG. 11 is a view illustrating the positional relationship between the cell cases and the enclosing member attached to the lower mold.

FIG. 12 is a perspective view showing a state where the upper mold is attached to the lower mold, on which the cell cases and the enclosing member are mounted.

FIG. 13 is a cross-sectional view showing a part along the line C-C in FIG. 10.

FIG. 14 is a perspective view showing a state where the cell cases and the enclosing member are integrated by the resin molded part.

FIG. 15 is a cross-sectional view taken along the line D-D in FIG. 12.

FIG. 16 is a perspective view illustrating a state where the electrode bodies are stored in the cell cases.

### DESCRIPTION OF THE EMBODIMENTS

Accordingly, the disclosure provides a battery module, which can integrate a plurality of battery cells with a simple structure without displacement and can be configured at low cost, and provides a manufacturing method of the battery module.

### Means for Solving the Problems

(1) A battery module (for example, the battery module 1 described later) according to the disclosure includes a plurality of battery cells (for example, the battery cells 3 described later) arranged therein. The battery cells are housed in an enclosing member (for example, the enclosing member 2 described later), which is open on upper and lower sides, to be surrounded by the enclosing member. Each of the battery cells stores an electrode body (for example, the electrode body 34 described later), which is formed by winding a collector foil (for example, the collector foil 340 described later), inside a cell case (for example, the cell case 33 described later) including long side walls (for example, the long side walls 331 described later) and short side walls (for example, the short side walls 332 described later), and has a space (for example, the space S described later) between a corner (for example, the corner 33c described later) where the long side wall and the short side wall intersect each other and the electrode body. The cell case has a recess (for example, the recess 37 described later) partially depressed toward the space at the corner. The battery module includes a resin molded part (for example, the resin molded part 4 described later) molded of a resin between the battery cells and the enclosing member and between the adjacent battery cells, and the resin (for example, the resin 41 described later) of the resin molded part enters the recess.

According to (1), it is possible to provide a battery module, which can integrate a plurality of battery cells with a simple structure without displacement and can be configured at low cost. Moreover, since the gap between the enclosing member and the battery cells and between the adjacent battery cells is filled with the integral resin molded part, the clearance around the battery cells is eliminated, by which the vibration resistance and cooling performance are also improved.

(2) In an embodiment of the battery module described in (1), the recess could be formed in a central portion of the cell case in a height direction or near the central portion.

According to (2), since the battery cell and the resin molded part are engaged with each other by protrusion/recess in the roughly central portion of the cell case in the height direction where the expansion coefficient is the largest, the integration of the battery cells and the resin molded part achieved through the recess can be further strengthened and the effect of preventing the displacement of the battery cells can be further enhanced.

(3) In an embodiment of the battery module described in (1) or (2), a position (for example, the position H4 described later) of an upper end surface (for example, the upper end surface 33a described later) of the cell case is higher than a position (for example, the position H3 described later) of an upper end surface (for example, the upper end surface 4a described later) of the resin molded part, and a sealing body (for example, the sealing body 31 described later) is disposed on an upper surface of the cell case.

According to (3), since the periphery of the sealing body is not covered by the resin molded part, after a plurality of cell cases are arranged in parallel and housed in the enclosing member, the sealing body can be easily attached by welding or the like, which is excellent for assembly workability of the battery module.

(4) In an embodiment of the battery module described in any one of (1) to (3), a position (for example, the position H2 described later) of an upper end surface (for example, the upper end surface 2a described later) of the enclosing member is the same as a position (for example, the position H1 described later) of an upper end surface (for example, the upper end surface 34a described later) of the electrode body or higher than the position of the upper end surface of the electrode body, a position of an upper end surface of the resin molded part is the same as the position of the upper end surface of the enclosing member or higher than the position of the upper end surface of the enclosing member, a position (for example, the position H21 described later) of a lower end surface (for example, the lower end surface 2b described later) of the enclosing member is the same as a position (for example, the position H11 described later) of a lower end surface (for example, the lower end surface 34b described later) of the electrode body or lower than the position of the lower end surface of the electrode body, and a position (for example, the position H31 described later) of a lower end surface (for example, the lower end surface 4b described later) of the resin molded part is the same as the position of the lower end surface of the enclosing member or lower than the position of the lower end surface of the enclosing member.

According to (4), since the periphery of the battery cell corresponding to the position of the electrode body can be reliably surrounded by the resin molded part and the enclosing member, the expansion of the battery cell can be effectively suppressed.

(5) The resin molded part could be disposed from an inner surface (for example, the inner surface 2c described later) of the enclosing member to the upper end surface and/or the lower end surface of the enclosing member.

According to (5), the resin molded part and the enclosing member can be integrated without being displaced upward and/or downward.

(6) In an embodiment of the battery module described in any one of (1) to (5), a thickness of the enclosing member at two end portions (for example, the short side frames 22 described later) in an arrangement direction of the battery cells is larger than a thickness of the enclosing member at two side portions (for example, the long side frames 21 described later) in the arrangement direction of the battery cells.

According to (6), since the portion, other than those where stress concentrates due to expansion of the battery cell, can be made thinner, the size and weight of the battery module can be reduced, and the cost can be further reduced.

(7) In an embodiment of the battery module described in any one of (1) to (6), the enclosing member could be an extrusion molded product formed by integrally extruding in a direction that is along the height direction of the battery cell.

According to (7), it is easy for the resin that forms the resin molded part to wrap around between the enclosing member and the battery cells, and the formability of the resin molded part is improved. Furthermore, since the adhesion between the enclosing member and the resin molded part is improved and the thermal conductivity is excellent, the cooling performance of the battery cells is further improved.

(8) A manufacturing method according to the disclosure is for manufacturing a battery module (for example, the battery module 1 described later), in which a plurality of battery cells (for example, the battery cells 3 described later) are arranged. The manufacturing method includes: a housing process of arranging and housing a plurality of cell cases (for example, the cell cases 33 described later) in an enclosing member (for example, the enclosing member 2 described later), which is open on upper and lower sides, so that the cell cases are surrounded by the enclosing member, wherein each of the cell cases has a recess (for example, the recess 37 described later) partially depressed toward an inner side of the cell case at a corner (for example, the corner 33c described later) where a long side wall (for example, the long side wall 331 described later) and a short side wall (for example, the short side wall 332 described later) of the cell case intersect each other; a resin molding process of forming a resin molded part (for example, the resin molded part 4 described later) by integrally molding a resin between the cell cases housed in the enclosing member and the enclosing member and between the adjacent cell cases, wherein the resin (for example, the resin 41 described later) of the resin molded part enters the recess; an electrode body storing process of storing an electrode body (for example, the electrode body 34 described later), which is formed by winding a collector foil (for example, the collector foil 340 described later), into each of the cell cases after the resin molded part is formed; and a sealing body attaching process of attaching a sealing body (for example, the sealing body 31 described later) to the cell case storing the electrode body.

According to (8), it is possible to provide a manufacturing method of a battery module, which can integrate a plurality of battery cells with a simple structure without displacement and can be configured at low cost.

(9) In an embodiment of the manufacturing method of the battery module described in (8), in the resin molding process, the resin molded part could be formed from an inner surface (for example, the inner surface 2c described later) of the enclosing member to an upper end surface (for example, the upper end surface 2a described later) and/or a lower end surface (for example, the lower end surface 2b described later) of the enclosing member.

According to (9), the enclosing member and the resin molded part can be easily integrated without being displaced upward and/or downward.

(10) In an embodiment of the manufacturing method of the battery module described in (8) or (9), the electrode body could be formed by winding the collector foil in a longitudinal direction, and in the electrode body storing process, the electrode body is stored in the cell case after two end portions (for example, the uncoated parts 342 described later) of the electrode body in a transverse direction are compressed in a thickness direction so that a space (for example, the space S described later) is formed between the electrode body and the corner when the electrode body is stored in the cell case.

According to (10), since the space can be formed between the electrode body and the corner of the cell case even if the electrode body is formed by winding the collector foil in the longitudinal direction, the electrode body can be stored into the cell case without interfering with the recess formed on the cell case.

### Effects

According to the disclosure, it is possible to provide a battery module, which can integrate a plurality of battery cells with a simple structure without displacement and can be configured at low cost, and provide a manufacturing method of the battery module.

Hereinafter, embodiments of the disclosure will be described in detail with reference to the figures.

### [Structure of the Battery Module]

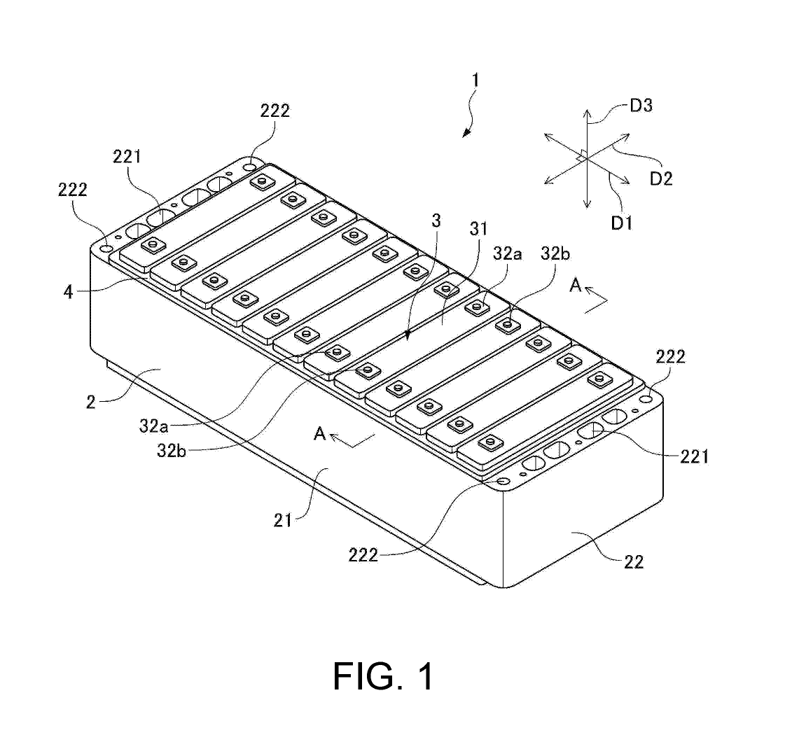

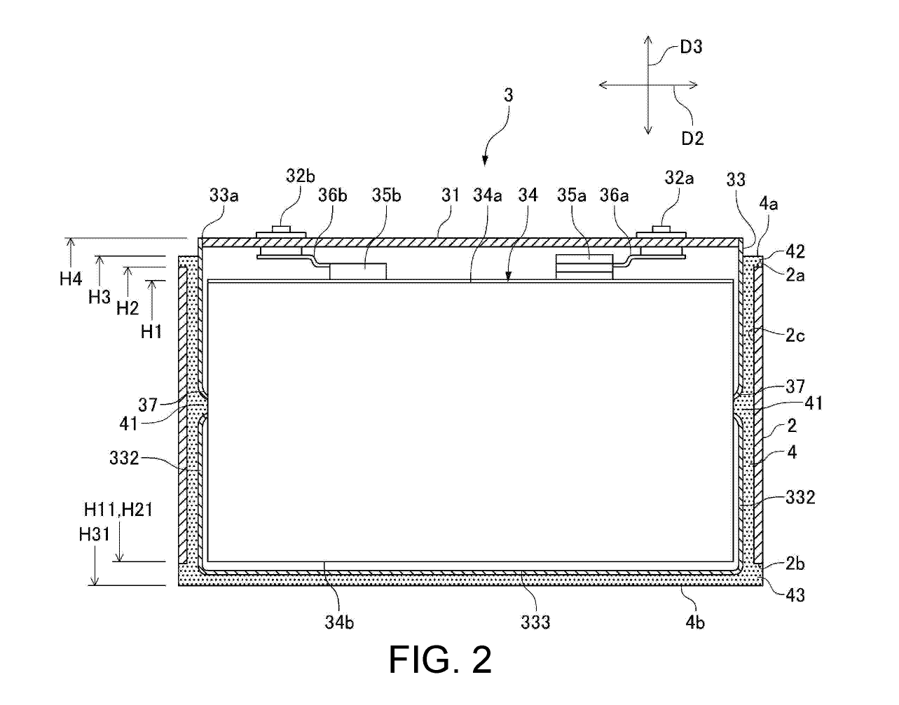

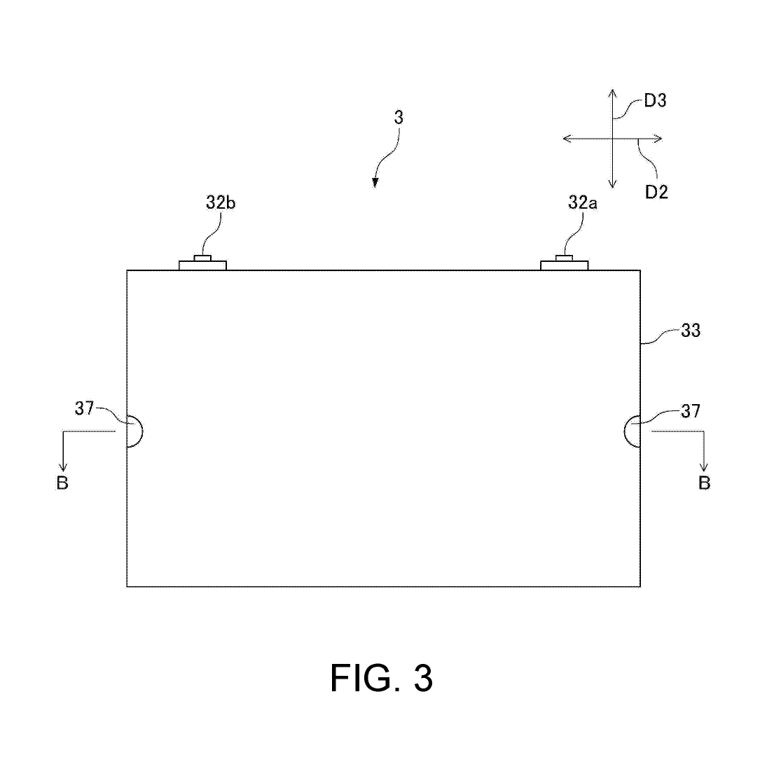

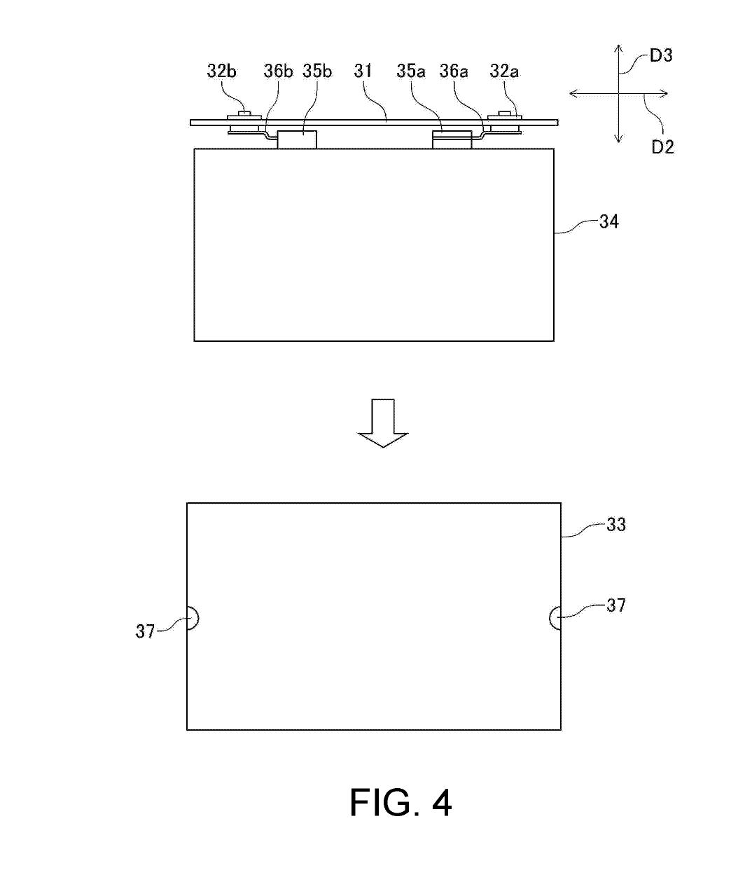

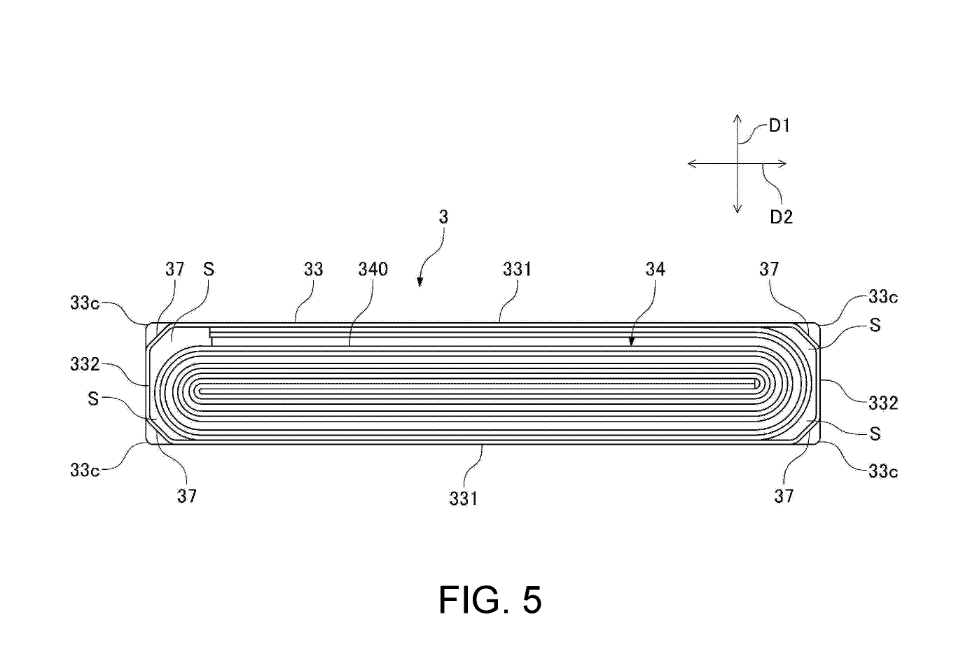

FIG. 1 is a perspective view of a battery module according to an embodiment of the disclosure. FIG. 2 is a cross-sectional view taken along the line A-A in FIG. 1. FIG. 3 is a front view of a battery cell. FIG. 4 is a front view showing the battery cell shown in FIG. 3 in an exploded manner. FIG. 5 is a cross-sectional view taken along the line B-B in FIG. 3. In the figures, D1, D2, and D3 indicate directions of the battery module 1. The direction D1 is the longitudinal direction of the battery module 1. The direction D2 is the transverse direction of the battery module 1. The direction D3 is the height direction of the battery module 1. The direction D1, the direction D2, and the direction D3 are orthogonal to one another. As shown in FIG. 1, the battery module 1 includes an enclosing member 2, a plurality of battery cells 3, and a resin molded part 4.

With a pair of long side frames 21 and 21 parallel to each other and a pair of short side frames 22 and 22 parallel to each other, the enclosing member 2 has a rectangular shape whose planar shape is long in the direction D1. The upper and lower sides of the enclosing member 2 along the direction D3 are open, and the space surrounded by the pair of long side frames 21 and 21 and the pair of short side frames 22 and 22 forms a housing space, in which a plurality of battery cells 3 are arranged in parallel and housed. The enclosing member 2 of the present embodiment is an extrusion molded product of aluminum or an aluminum alloy, formed by integrally extruding the long side frames 21 and the short side frames 22 along the height direction (the direction D3) of the battery cells 3.

The short side frames 22 of the enclosing member 2 are formed thicker than the long side frames 21. A plurality of through holes 221 and 222 that penetrate in the vertical direction are formed in the short side frames 22. These through holes 221 and 222 are effective in reducing the weight of the enclosing member 2 and can be used for circulating a cooling fluid (such as cooling water and cooling air) to cool the battery module 1. The through holes 222 at the four corners are also used when the enclosing member 2 is positioned in the mold in the manufacturing method, which will be described later.

The battery cell 3 is configured by storing an electrode body 34 inside a cell case 33, which is formed of aluminum or an aluminum alloy in a rectangular parallelepiped shape. Specifically, as shown in FIG. 2 and FIG. 5, the cell case 33 is formed in a box shape, which is open on the upper side, by a pair of long side walls 331 and 331 parallel to each other, a pair of short side walls 332 and 332 parallel to each other, and a bottom wall 333. The upper surface of the cell case 33 is covered by welding a sealing body 31. A positive electrode terminal 32a and a negative electrode terminal 32b are disposed on the upper surface of the sealing body 31.

The electrode body 34 is formed by winding a collector foil 340. As shown in FIG. 5, the electrode body 34 of the present embodiment is formed by winding the collector foil 340 in the transverse direction around an axis that extends in the vertical direction (the direction D3). The electrode body 34 is shaped into an elongated shape in the transverse direction (the direction D2) in accordance with the internal space of the rectangular parallelepiped cell case 33.

A positive electrode current collector 35a and a negative electrode current collector 35b protrude on the upper portion of the electrode body 34. The positive electrode current collector 35a is electrically connected to the positive electrode terminal 32a of the sealing body 31 via an in-cell bus bar 36a, and the negative electrode current collector 35b is electrically connected to the negative electrode terminal 32b of the sealing body 31 via an in-cell bus bar 36b. As shown in FIG. 4, the electrode body 34 is stored in the cell case 33 in a state of being connected to the sealing body 31 by the in-cell bus bars 36a and 36b.

A recess 37 is formed at a corner 33c where the long side wall 331 and the short side wall 332 of the rectangular parallelepiped cell case 33 intersect each other. As shown in FIG. 5, two end portions of the electrode body 34, formed by winding the collector foil 340 in the transverse direction, in the direction D2 are semicircular. Therefore, predetermined spaces S are respectively formed between the corners 33c of the cell case 33 and the two end portions of the electrode body 34. The recess 37 is partially depressed toward the space S at the corner 33c of the cell case 33. As shown in FIG. 5, the inward protrusion amount of each recess 37 remains within the space S. Therefore, the recess 37 does not interfere with the electrode body 34 at all.

The recess 37 is formed by partially press-molding the corner 33c of the cell case 33 toward the inner side. Since it is unnecessary to scrape the cell case 33 to form the recess 37, there is no possibility of reducing the strength of the cell case 33. Nevertheless, the recess 37 is not limited to a specific cross-sectional shape as long as it has a shape partially recessed toward the space S.

A plurality of battery cells 3 are arranged in parallel along the direction D1 with their long side walls 331 arranged along the direction D2, and are housed in the housing space surrounded by the long side frames 21 and the short side frames 22 of the enclosing member 2. The adjacent battery cells 3 and 3 are disposed so that their positive electrode terminals 32a and negative electrode terminals 32b are arranged alternately. The adjacent positive electrode terminal 32a and negative electrode terminal 32b are electrically connected by a bus bar or the like (not shown), and the battery cells 3 are connected in series. Nevertheless, the battery cells 3 and the enclosing member 2, and the adjacent battery cells 3 and 3 are not in direct contact with each other, but are separated at a predetermined distance.

The resin molded part 4 is formed of an insulating resin such as polyethylene and polypropylene, and is provided integrally between the battery cells 3 and the enclosing member 2 and between the adjacent battery cells 3 and 3. Specifically, the resin molded part 4 is disposed in a gap between the battery cells 3 and the enclosing member 2 and in a gap between the adjacent battery cells 3 and 3. The resin molded part 4 integrates multiple arranged battery cells 3 and the enclosing member 2 and the adjacent battery cells 3 and 3 respectively, and insulates between the adjacent battery cells 3 and 3. As shown in FIG. 2, the resin molded part 4 is formed integrally from the side surfaces (the long side wall 331 and the short side wall 332) to the lower surface (the bottom wall 333) of the battery cell 3.

As shown in FIG. 2, a resin 41 of the resin molded part 4 enters each recess 37 formed on the cell case 33 of each battery cell 3. Therefore, each battery cell 3 is integrated with the resin molded part 4 through protrusion/recess engagement. The protrusion/recess engagement between the resin 41 of the resin molded part 4 and the recess 37 of the battery cell 3 as described above better prevents the movement of the battery cell 3 in the vertical direction (the direction D3) than the case where the side surfaces (the long side wall 331 and the short side wall 332) of the battery cell 3 and the resin molded part 4 are in contact only by planar surfaces.

Therefore, according to the battery module 1, a plurality of battery cells 3 can be integrally held on the inner side of the enclosing member 2 without displacement. Since it is unnecessary to use a separate part such as the conventional metal band or dispose a separator between the adjacent battery cells 3 and 3 to arrange and integrate multiple battery cells 3 in parallel, the number of parts can be reduced to simplify the structure of the battery module 1 and reduce the cost. Moreover, since the gap between the enclosing member 2 and the battery cells 3 and the gap between the adjacent battery cells 3 and 3 are filled with the integral resin molded part 4, the clearance around the battery cells 3 is eliminated, by which vibration resistance and cooling performance are also improved.

In addition, since the enclosing member 2 is an extrusion molded product formed by integrally extruding the long side frames 21 and the short side frames 22 along the height direction (the direction D3) of the battery cell 3, the inner surface 2c of the enclosing member 2 is a simple planar surface without a joint. Therefore, the resin that forms the resin molded part 4 easily wraps around between the enclosing member 2 and the battery cells 3, and the formability of the resin molded part 4 is improved. Furthermore, since the adhesion between the enclosing member 2 and the resin molded part 4 is improved and the thermal conductivity is excellent, the cooling performance of the battery cells 3 is further improved. In order to improve the adhesion between the enclosing member 2 and the battery cells 3 and the resin molded part 4, a mechanical or chemical surface roughening process may be applied to the inner surface 2c of the enclosing member 2 and/or the side surfaces (the long side wall 331 and the short side wall 332) of the cell case 33 to an extent that does not hinder the resin from wrapping around.

In the present embodiment, the recess 37 formed on the cell case 33 of the battery cell 3 is disposed in the central portion of the cell case 33 in the height direction (the direction D3), as shown in FIG. 2 and FIG. 3. Since the central portion of the cell case 33 in the height direction is the portion that has the largest expansion coefficient when the battery cell 3 expands due to charging and discharging, the protrusion/recess engagement between the battery cells 3 and the resin molded part 4 is strengthened. Thus, the effect of preventing the displacement of the battery cells 3 can be further enhanced.

Nevertheless, the recess 37 may not be strictly disposed in the central portion of the cell case 33 in the height direction (the direction D3) and may be disposed near the central portion of the cell case 33 in the height direction (the direction D3). In addition, although only one recess 37 is formed at each corner 33c of the cell case 33 in the present embodiment, a plurality of recesses 37 may be formed at different heights at one corner 33c. Furthermore, it suffices if the recess 37 is formed at least one of the four corners 33c. However, from the viewpoint of enhancing the effect of preventing the displacement of the battery cells 3, the recesses 37 could be formed at any two or more of the corners 33c, such as the two corners 33c at diagonal positions among the four corners 33c, and the recesses 37 could be formed at all the corners 33c as in the present embodiment.

As shown in FIG. 2, the position H3 of an upper end surface 4a of the resin molded part 4 is higher than the position H2 of an upper end surface 2a of the enclosing member 2. However, the position H4 of an upper end surface 33a of the cell case 33 is higher than the position H3 of the upper end surface 4a of the resin molded part 4. Therefore, the periphery of the sealing body 31 is not covered by the resin molded part 4. Thus, after a plurality of cell cases 33 are arranged in parallel and housed in the enclosing member 2, the sealing body 31 can be attached easily by welding or the like, which is excellent for the assembly workability of the battery module 1.

Moreover, the position H2 of the upper end surface 2a of the enclosing member 2 could be the same as the position H1 of an upper end surface 34a of the electrode body 34 in the battery cell 3 or higher than the position H1 of the upper end surface 34a of the electrode body 34, the position H3 of the upper end surface 4a of the resin molded part 4 is the same as the position H2 of the upper end surface 2a of the enclosing member 2 or higher than the position H2 of the upper end surface 2a of the enclosing member 2, the position H21 of a lower end surface 2b of the enclosing member 2 is the same as the position H11 of a lower end surface 34b of the electrode body 34 or lower than the position H11 of the lower end surface 34b of the electrode body 34, and the position H31 of a lower end surface 4b of the resin molded part 4 is the same as the position H21 of the lower end surface 2b of the enclosing member 2 or lower than the position of the lower end surface 2b of the enclosing member 2. Since the periphery of the battery cell 3 corresponding to the position of the electrode body 34 can be reliably surrounded by the resin molded part 4 and the enclosing member 2, the expansion of the battery cell 3 can be effectively suppressed.

Further, as shown in FIG. 2, the resin molded part 4 could be disposed from the inner surface 2c of the enclosing member 2 to the upper end surface 2a of the enclosing member 2. That is, at the upper end of the resin molded part 4, an upper covering part 42 is formed to cover the upper end surface 2a of the enclosing member 2. Thus, the resin molded part 4 is integrated without being displaced upward with respect to the enclosing member 2. Similarly, the resin molded part 4 could be disposed from the inner surface 2c of the enclosing member 2 to the lower end surface 2b of the enclosing member 2. That is, at the lower end of the resin molded part 4, a lower covering part 43 is formed to cover the lower end surface 2b of the enclosing member 2. Thus, the enclosing member 2 is integrated without being displaced downward with respect to the resin molded part 4. Therefore, with either one or both of them, the effect of preventing the displacement between the enclosing member 2 and the resin molded part 4 can be further enhanced.

Regarding the enclosing member 2 shown in the present embodiment, as shown in FIG. 1, the thickness of the short side frames 22 disposed at two end portions in the arrangement direction (the direction D1) of the battery cells 3 is larger than the thickness of the long side frames 21 disposed at two side portions in the arrangement direction (the direction D1) of the battery cells 3. Since the short side frame 22 is the portion where stress concentrates when the battery cell 3 expands, it is set to a necessary and sufficient thickness. On the other hand, such stress during expansion is hardly applied to the long side frame 21. Since the long side frames 21 only need to have the main function of connecting the short side frames 22 and 22, them can be made thinner than the short side frames 22 to reduce the size and weight of the battery module 1 and further to reduce the cost.

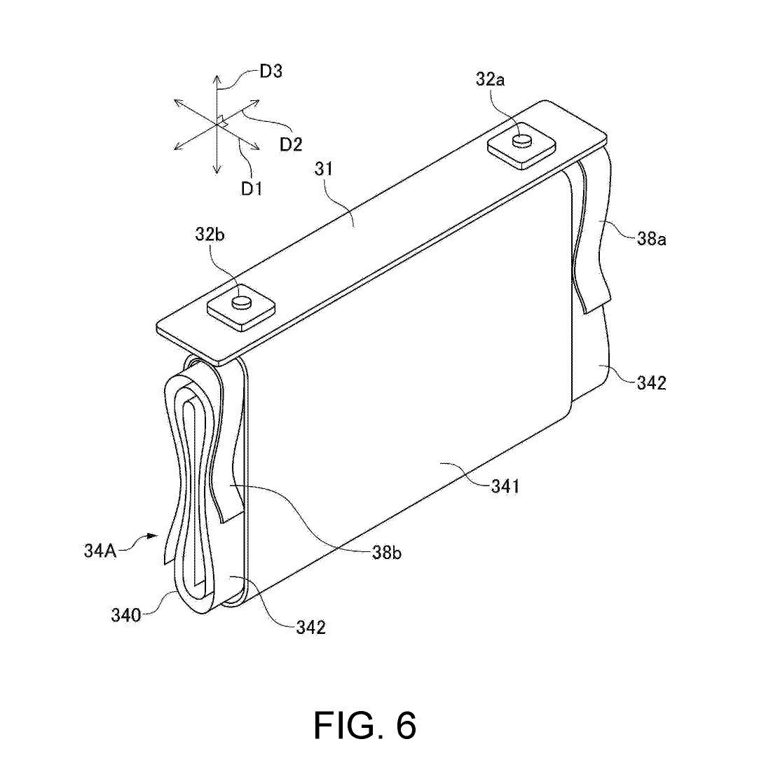

Although the battery cell 3 of the embodiment described above stores the electrode body 34 that is formed by winding the collector foil 340 in the transverse direction, the electrode body may be an electrode body 34A that is formed by winding the collector foil 340 in the longitudinal direction, as shown in FIG. 6. The electrode body 34A is formed by winding the collector foil 340 in the longitudinal direction around an axis that extends in the transverse direction (the direction D2).

As shown in FIG. 6, the electrode body 34A has uncoated parts 342 and 342, which are not coated with a mixture, at two end portions of a coated part 341 that is coated with the mixture. The in-cell bus bars 38a and 38b electrically connected to the positive electrode terminal 32a and the negative electrode terminal 32b respectively are electrically connected to the uncoated parts 342 and 342 so as to hold the uncoated parts 342 and 342. In the electrode body 34A, the uncoated parts 342 and 342 at where the in-cell bus bars 38a and 38b are disposed are compressed in the thickness direction, and the thickness is partially reduced.

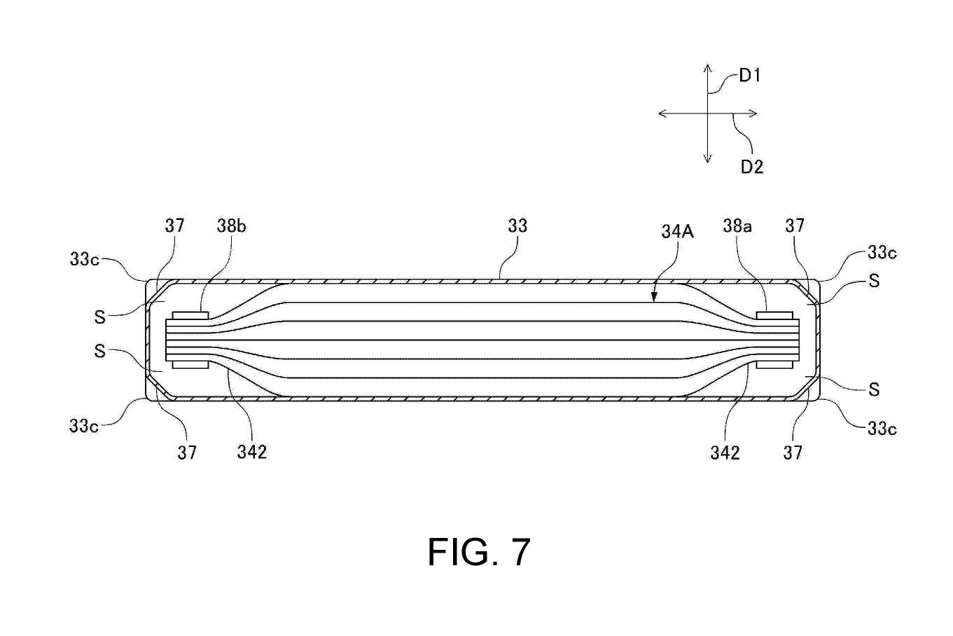

Unlike the electrode body 34 formed by winding the collector foil 340 in the transverse direction, as shown in FIG. 5, two end portions of the electrode body 34A formed by winding the collector foil 340 in the longitudinal direction are not semicircular. However, by compressing the uncoated parts 342 and 342 at the two end portions of the electrode body 34A in the thickness direction, as shown in FIG. 7, when the electrode body 34A is stored in the cell case 33, a predetermined space S can be formed between the corner 33c and the electrode body 34A. Therefore, in the case where the battery cell 3 includes such an electrode body 34A, it is also possible to form the recess 37 without interfering with the electrode body 34A inside.

### [Manufacturing Method of the Battery Module]

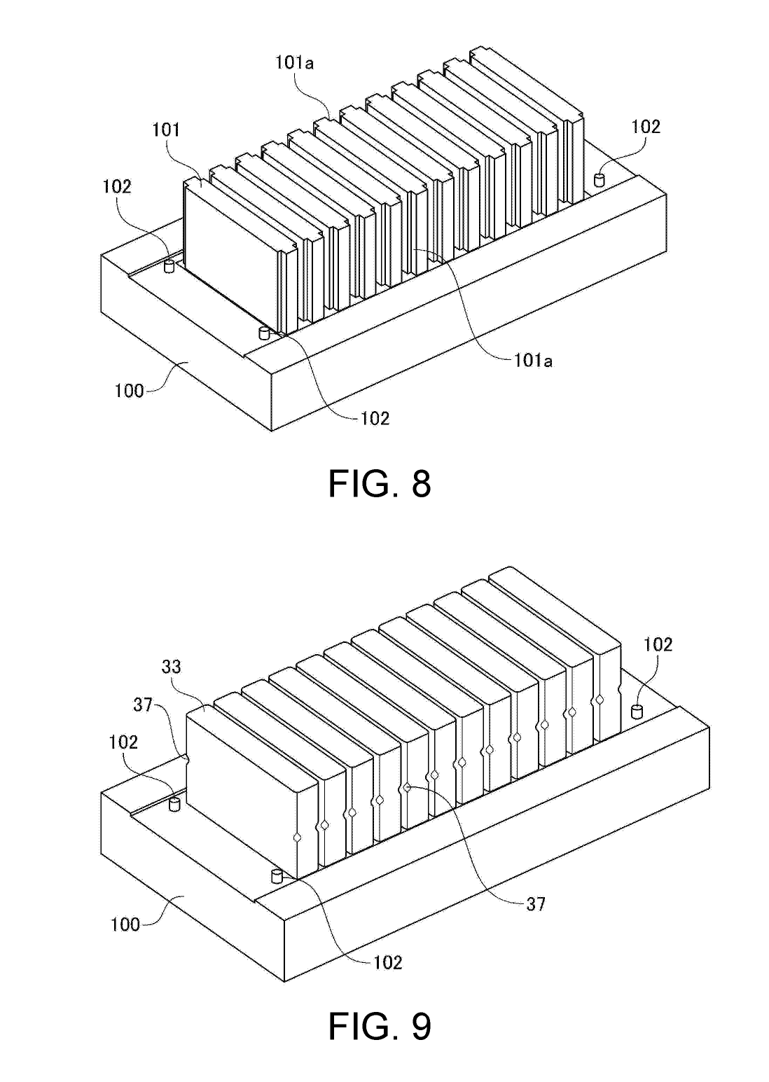

Next, an example of the manufacturing method of the battery module 1 will be described with reference to FIG. 8 to FIG. 16. As shown in FIG. 8, a plurality of cell case holding parts 101 protrude on the upper surface of a lower mold 100 for resin molding. The cell case holding part 101 is formed in the same shape as the internal space of the cell case 33 of the battery cell 3. Moreover, the cell case holding parts 101 are arranged in parallel on the upper surface of the lower mold 100 in the same form as the parallel arrangement of the battery cells 3. Grooves 101a are respectively formed along the height direction of the cell case holding part 101 at corners of the cell case holding part 101 corresponding to the corners 33c of the cell case 33. The groove 101a has a depth corresponding to the inward protrusion amount of the recess 37 formed on the cell case 33. In addition, a plurality of positioning protrusions 102 for positioning the enclosing member 2 protrude on the upper surface of the lower mold 100.

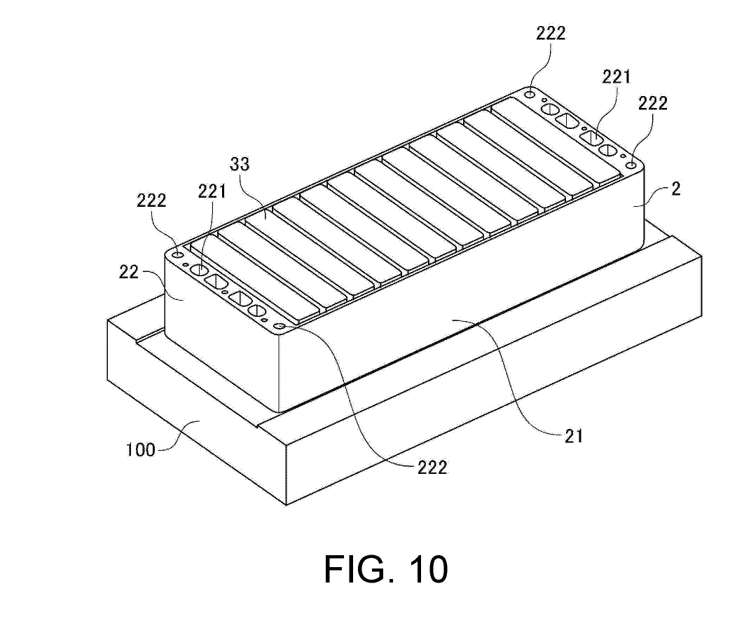

As shown in FIG. 9, the cell cases 33 are respectively fitted and attached to the cell case holding parts 101 of the lower mold 100, and the cell cases 33 are arranged. Each cell case 33 is formed with the recess 37 in advance. Next, as shown in FIG. 10, the enclosing member 2 is mounted on the lower mold 100. At this time, the enclosing member 2 is mounted with the lower end surface 2b shown in FIG. 2 on the upper side. The enclosing member 2 is mounted to surround all the cell cases 33 that are arranged in parallel. The positioning protrusions 102 of the lower mold 100 are respectively engaged with the through holes 222 formed in the short side frames 22 of the enclosing member 2. As a result, the enclosing member 2 is positioned at a proper position with respect to the lower mold 100. Thus, a plurality of cell cases 33 are arranged in parallel and housed in the enclosing member 2 (housing process).

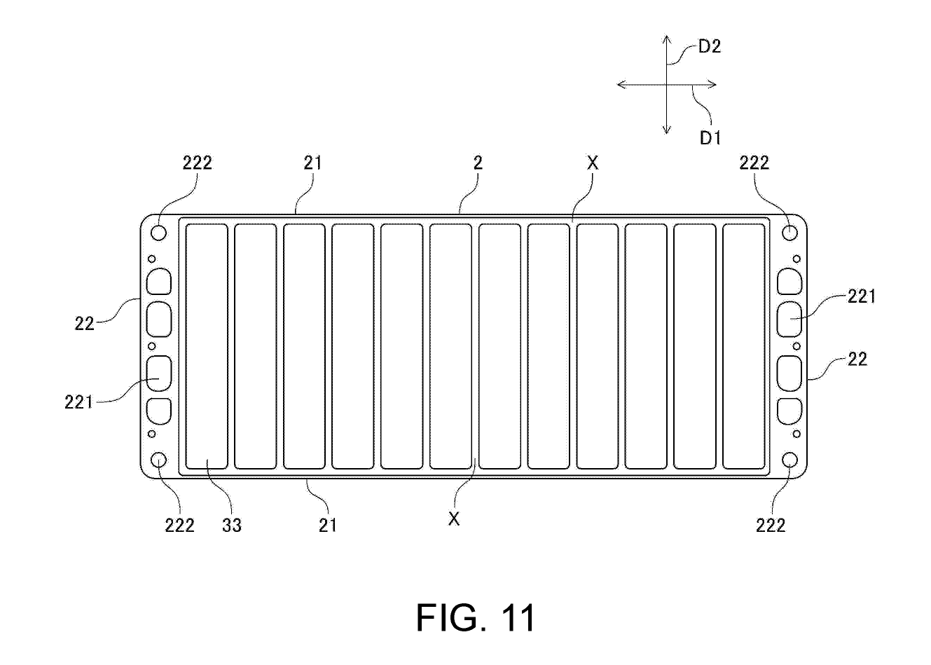

As shown in FIG. 11, in a state where the cell cases 33 and the enclosing member 2 are positioned, a gap X is formed between the enclosing member 2 and each cell case 33 and between the adjacent cell cases 33 and 33 to serve as the flow passage for the resin, which will be described later.

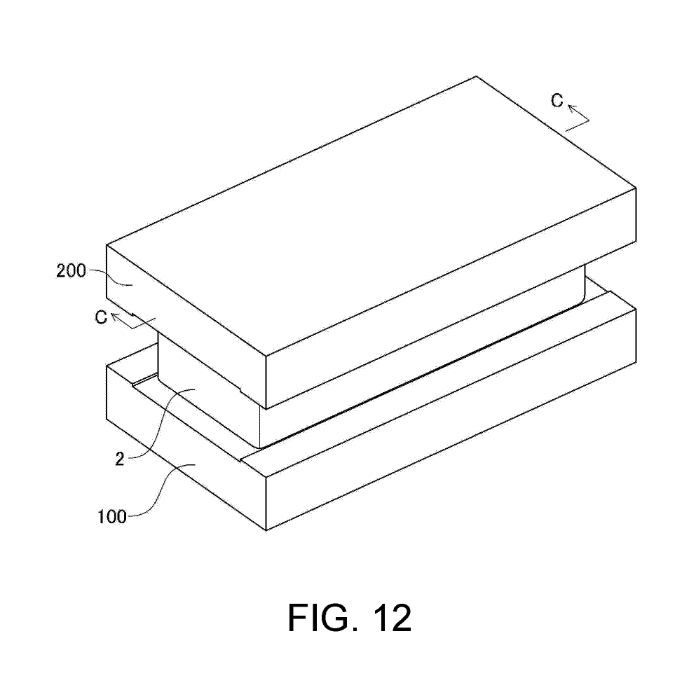

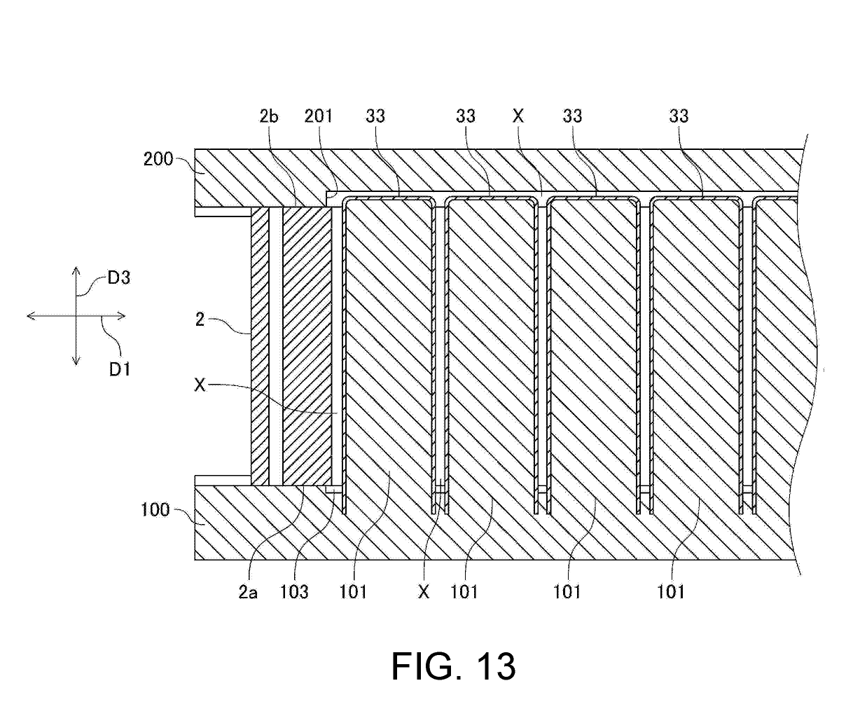

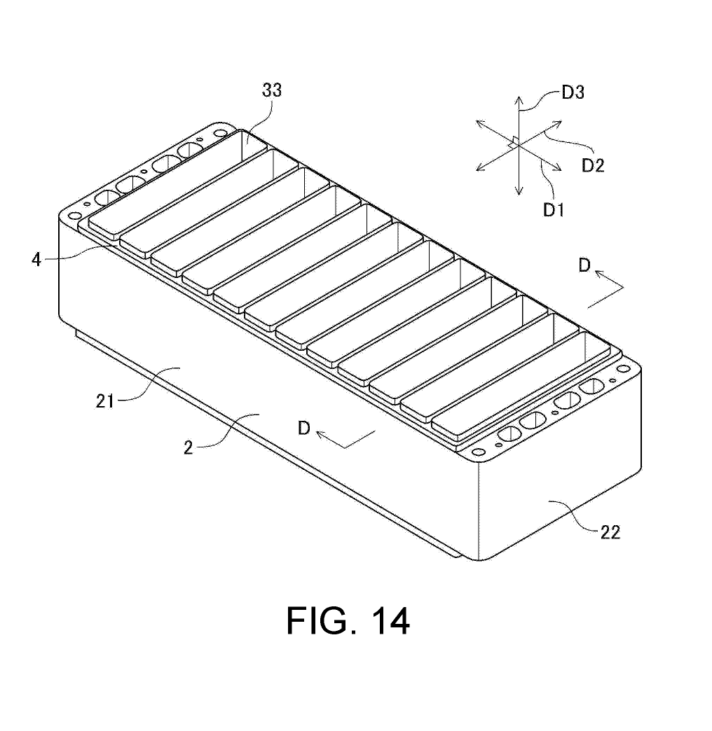

Then, as shown in FIG. 12, an upper mold 200 is placed on the upper side of the cell cases 33 and the enclosing member 2. As shown in FIG. 13, the upper mold 200 is placed on the lower end surface 2b of the enclosing member 2, which is on the upper side. The gap X that serves as the flow passage for the resin, which will be described later, is also formed between the upper mold 200 and each cell case 33. Then, the resin for molding is injected into the gap X respectively formed between the lower mold 100, the upper mold 200, the cell cases 33, and the enclosing member 2 to form the resin molded part 4. Thus, as shown in FIG. 14, a plurality of cell cases 33 arranged in parallel and the enclosing member 2 are integrated by the resin molded part 4. At this time, the resin 41 of the resin molded part 4 enters the recess 37 formed on each cell case 33, by which the cell cases 33 and the resin molded part 4 are integrated in the protrusion/recess engagement state (resin molding process).

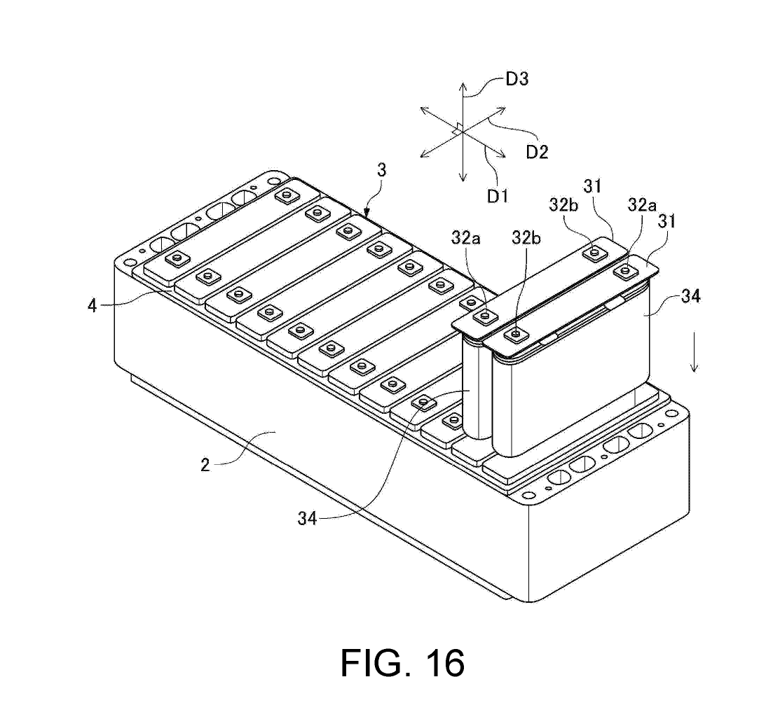

Next, as shown in FIG. 16, the electrode body 34 is stored in each of the cell cases 33 integrated with the enclosing member 2 by the resin molded part 4 (electrode body storing process). Here, the electrode body 34 is for example formed by winding the collector foil 340 in the transverse direction, as shown in FIG. 5. The electrode body 34 is integrated with the sealing body 31 in advance. Therefore, each battery cell 3 can be configured simply by storing the electrode body 34 with the sealing body into each cell case 33. Since the inward protrusion amount of the recess 37 on each cell case 33 remains within the space S so that the recess 37 does not interfere with the electrode body 34, there is no interference when the electrode body 34 is stored into the cell case 33. Thereafter, the sealing body 31 is fixed to the cell case 33 by welding or the like (sealing body attaching process).

According to the manufacturing method, by simply forming the resin molded part 4, the cell cases 33 of multiple battery cells 3 can be held integrally on the inner side of the enclosing member 2 without displacement. Since it is unnecessary to use a separate part such as the conventional metal band or dispose a separator between the adjacent battery cells 3 and 3, the number of parts can be reduced, and the battery module 1 can be configured with a simple structure at low cost.

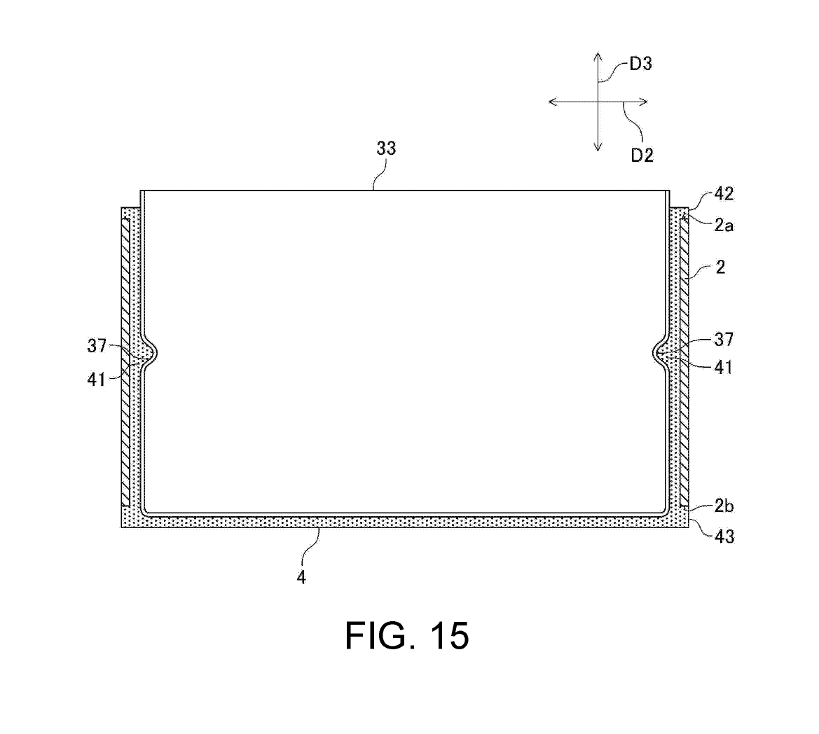

In the manufacturing method shown in the present embodiment, as shown in FIG. 15, the upper covering part 42 and the lower covering part 43 are integrally formed in the resin molded part 4, wherein the upper covering part 42 covers the upper end surface 2a of the enclosing member 2 and the lower covering part 43 covers the lower end surface 2b of the enclosing member 2. Therefore, the enclosing member 2 and the resin molded part can be integrated easily without being displaced upward and downward. It is also possible to form only one of the upper covering part 42 and the lower covering part 43.

In the case where the electrode body 34A is formed by winding the collector foil 340 in the longitudinal direction, as shown in FIG. 6 and FIG. 7, the electrode body 34A could be stored into the cell case 33 after compressing the uncoated parts 342 and 342 positioned at two end portions in the transverse direction of the electrode body 34A in the thickness direction, so as to form the space S between the electrode body 34A and the corner 33c of the cell case 33 when the electrode body 34A is stored in the cell case 33. Since the space S can be formed between the electrode body 34A and the corner 33c of the cell case 33 even if the electrode body 34A is formed by winding the collector foil 340 in the longitudinal direction, the electrode body 34A can be stored into the cell case 33 without interfering with the recess 37 formed on the cell case 33.

What is claimed is:

1. A battery module, in which a plurality of battery cells are arranged, wherein:
the battery cells are housed in an enclosing member, which is open on upper and lower sides, to be surrounded by the enclosing member,
each of the battery cells stores an electrode body, which is formed by winding a collector foil, inside a cell case comprising long side walls and short side walls, and has a space between a corner where the long side wall and the short side wall intersect each other and the electrode body,
the cell case has a recess partially depressed toward the space at the corner, and
the battery module comprises a resin molded part molded of a resin between the battery cells and the enclosing member and between the adjacent battery cells, and the resin of the resin molded part enters the recess.

2. The battery module according to claim 1, wherein the recess is formed in a central portion of the cell case in a height direction or near the central portion.

3. The battery module according to claim 2, wherein a position of an upper end surface of the cell case is higher than a position of an upper end surface of the resin molded part, and
a sealing body is disposed on an upper surface of the cell case.

4. The battery module according to claim 1, wherein a position of an upper end surface of the cell case is higher than a position of an upper end surface of the resin molded part, and
a sealing body is disposed on an upper surface of the cell case.

5. The battery module according to claim 2, wherein a position of an upper end surface of the enclosing member is the same as a position of an upper end surface of the electrode body or higher than the position of the upper end surface of the electrode body,
a position of an upper end surface of the resin molded part is the same as the position of the upper end surface of the enclosing member or higher than the position of the upper end surface of the enclosing member,
a position of a lower end surface of the enclosing member is the same as a position of a lower end surface of the electrode body or lower than the position of the lower end surface of the electrode body, and
a position of a lower end surface of the resin molded part is the same as the position of the lower end surface of the enclosing member or lower than the position of the lower end surface of the enclosing member.

6. The battery module according to claim 1, wherein a position of an upper end surface of the enclosing member is the same as a position of an upper end surface of the electrode body or higher than the position of the upper end surface of the electrode body,
a position of an upper end surface of the resin molded part is the same as the position of the upper end surface of the enclosing member or higher than the position of the upper end surface of the enclosing member,
a position of a lower end surface of the enclosing member is the same as a position of a lower end surface of the electrode body or lower than the position of the lower end surface of the electrode body, and
a position of a lower end surface of the resin molded part is the same as the position of the lower end surface of the enclosing member or lower than the position of the lower end surface of the enclosing member.

7. The battery module according to claim 2, wherein the resin molded part is disposed from an inner surface of the enclosing member to the upper end surface and/or the lower end surface of the enclosing member.

8. The battery module according to claim 1, wherein the resin molded part is disposed from an inner surface of the enclosing member to the upper end surface and/or the lower end surface of the enclosing member.

9. The battery module according to claim 2, wherein a thickness of the enclosing member at two end portions in an arrangement direction of the battery cells is larger than a thickness of the enclosing member at two side portions in the arrangement direction of the battery cells.

10. The battery module according to claim 1, wherein a thickness of the enclosing member at two end portions in an arrangement direction of the battery cells is larger than a thickness of the enclosing member at two side portions in the arrangement direction of the battery cells.

11. The battery module according to claim 2, wherein the enclosing member is an extrusion molded product formed by integrally extruding in a direction that is along the height direction of the battery cell.

12. The battery module according to claim 1, wherein the enclosing member is an extrusion molded product formed by integrally extruding in a direction that is along the height direction of the battery cell.

13. A manufacturing method of a battery module, in which a plurality of battery cells are arranged, the manufacturing method comprising:
a housing process of arranging and housing a plurality of cell cases in an enclosing member, which is open on upper and lower sides, so that the cell cases are surrounded by the enclosing member, wherein each of the cell cases has a recess partially depressed toward an inner side of the cell case at a corner where a long side wall and a short side wall of the cell case intersect each other;
a resin molding process of forming a resin molded part by integrally molding a resin between the cell cases housed in the enclosing member and the enclosing member and between the adjacent cell cases, wherein the resin of the resin molded part enters the recess;
an electrode body storing process of storing an electrode body, which is formed by winding a collector foil, into each of the cell cases after the resin molded part is formed; and
a sealing body attaching process of attaching a sealing body to the cell case storing the electrode body.

14. The manufacturing method of the battery module according to claim 13, wherein in the resin molding process, the resin molded part is formed from an inner surface of the enclosing member to an upper end surface and/or a lower end surface of the enclosing member.

15. The manufacturing method of the battery module according to claim 14, wherein the electrode body is formed by winding the collector foil in a longitudinal direction, and
in the electrode body storing process, the electrode body is stored in the cell case after two end portions of the electrode body in a transverse direction are compressed in a thickness direction so that a space is formed between the electrode body and the corner when the electrode body is stored in the cell case.

16. The manufacturing method of the battery module according to claim 13, wherein the electrode body is formed by winding the collector foil in a longitudinal direction, and
in the electrode body storing process, the electrode body is stored in the cell case after two end portions of the electrode body in a transverse direction are compressed in a thickness direction so that a space is formed between the electrode body and the corner when the electrode body is stored in the cell case.
